(19) United States
(12) Patent Application Publication
(10) Pub. No.: US 2021/0350402 A1
(43) Pub. Date: Nov. 11, 2021

(54) SYSTEM AND METHOD FOR EFFICIENT INVENTORY MANAGEMENT

(71) Applicant: Bassem ABURUGAIEH, Amman (JO)

(72) Inventor: Bassem ABURUGAIEH, Amman (JO)

(21) Appl. No.: 17/272,270

(22) PCT Filed: Jan. 18, 2019
(86) PCT No.: PCT/JO2019/050007

§ 371 Date: Feb. 26, 2021

(51) Int. Cl. G06Q 30/02; G06Q 10/08; G06Q 30/06; G06F 16/28

(52) U.S. Cl. CPC G06Q 30/0223; G06Q 10/087; G06Q 30/0222; G06F 16/285; G06Q 30/0641; G06Q 30/0623; G06Q 30/0235

(57) ABSTRACT

The present invention relates to a system (100) and method for inventory management of near expiry perishable goods such as food stuffs, pharmaceuticals, cosmetics and chemicals. The method consists in providing an electronic database (102) managed by a computer platform for near expiry perishable goods. The platform allows sellers of near expiry items to advertise their merchandise and allows customers to buy the near expiry items at discounted prices.

### BACKGROUND OF THE INVENTION

### Field of the Invention

The present invention relates to a system and method for the efficient management of an inventory. In particular, the present disclosure is to provide for an efficient system and method for managing perishable inventory whereby said system and method minimizes waste due to expiration or near-expiration of said perishable products; and maximizes owner and customer satisfaction and return on said perishable products.

### Background of the Invention

It is a well-known fact reported in the media and statistically confirmed by a number of local, regional and international organizations, both government and non-government (NGO), that the amount of waste generated daily as a result of expired perishable products is a global problem. The problem extends to food products whereby a number of regions in the world experience famine; and medical products, whereby a number of regions experience lack of proper healthcare. It is not the intention of the present invention to dwell upon the socio- and politico-economic problems of the world. Rather, it is the goal of the present invention to provide for an improved management system and method whereby near expiry and expiring product are monitored and distributed in the most efficient way. By providing for such a system and method, it is submitted that the amount of generated waste will decrease thus driving prices down through an improved management of existing inventories and also by making available discounted products as needed as a result of minimizing, even removing, the potential for expired products in said inventory.

The areas affected by this type of waste and which could benefit from an improved system and method of managing inventory include, but are not limited to, produce, i.e. fruits and vegetables, meat and poultry, canned foods, medical and paramedical products, cosmetics, chemical and agrochemical products. Such losses due to expiration affect the profitability chain from the producer, to the manufacturer to the seller. These losses are accounted for in the pricing of the products in question, which in turn affect negatively the purchasing power of the consumer. In a catch-22 scenario: the higher the cost, the lower the purchasing ability; the lower the purchasing ability, the higher the waste due to expiration; the higher the waste, the higher the cost. The ability then to address one of the driving forces of this cycle, would correct this model. The ability to minimize waste will lead to lower cost which in turn will lead to a stronger purchasing power thus further minimizing waste and so the cycle goes. The subject of the present invention is to provide a system and method whereby this cycle is disrupted by addressing precisely the waste generated from expired products and to provide a solution to said waste throughout the supply chain.

Chain stores, grocery stores, pharmacies, hospitals and any and all other businesses that hold inventory for perishable goods and products are wary of the expiration of such products. In order to minimize losses due to expired inventory, businesses in such cases apply first-expired, first-sell policies whereby near expiring products are pushed for sale maybe even under promotional deals to avoid holding costly wasted inventory.

This applies also to online stores and mostly affects the end consumer which may not necessarily have access to the expiration date of the online ordered and purchased products. Certain consumers will return such products and request refunds. Such a reaction generates bad review on the seller, distrust from the consumer side and in the end, and place the product in the waste category.

The volume of products managed can be large enough such a viable and dependable solution is made available to create a cycle whereby perishable products reach the different stakeholders within a supply chain with a satisfactory expiration date lead thus minimizing the resulting waste of unsatisfactory near expiring products. such a solution is time and effort consuming and possibly unattainable without an adequate integrated system which empowers the stakeholders in said supply chain to adequately monitor and dispose of inventory in a timely manner to minimize and possibly avoid build-up of near expiry perishable products.

Systems to manage inventory of near expiry items have been proposed and addressed in the prior art. A number of studies have been conducted to assess the global cost of such waste, to raise awareness thereof and to offer solutions. A number of patents and patent applications disclose various systems and methods which attempt to manage the inventory of near expiry items. By the latter, owners of the inventory are rewarded by not being obligated to hold expiring or near expiration products.

As an example, US2009125684 (A1) provides a timer device adapted to monitor time periods associated with foods and other substances which may have a finite time during which they are suitable for use, comprising a timer unit (8) capable of monitoring a plurality of time periods, each time period being associated with a tag (1) identifiable by a unique code such as an alphanumeric code. The tags (1) are attachable to a product such as a lid (2) of a food jar, and its identifiable code may be entered on a key pad (12) of the unit (8) such that the period during which the tag has been attached to the jar is monitored on the timer unit (8) and may be read at any time during the preselected period during which the product in the jar is usable. The device assists in ensuring safe use of products and reduces product wastage.

US2012278190 (A1) discloses a method for shelf life expiration date management for smart refrigerators. The method includes identifying a consumer during a point of sale transaction for purchasing different food items by a point of sale computer system, for example by scanning a bar code or reading a magnetic strip of a loyalty program card or reading a radio frequency identification (RFID) dongle. A list of the different food items can be provided to the smart refrigerator, for example from storage in the loyalty program card or RFID dongle, or as transmitted from the point of sale computer system to the smart refrigerator over a computer communications network. Finally, expiration dates can be determined for the food items in the list and stored in the smart refrigerator.

US2015048938 (A1) discloses a monitoring system for use with a perishable product. The monitoring system comprises a sensor assembly, an indicator, a user input, and a processor. The processor is configured to determine from the output of the sensor assembly whether or not the perishable product has expired, and, in response to activation of the user input, to cause the indicator to indicate whether the perishable product has expired.

None of the prior art documents provide a system or method for the inventory management of near expiry products throughout the supply chain integrating an easy to use solution which tracks a product within the supply chain and is accessible to all stakeholders involved and implicated in said supply chain. The object of the present invention is to provide a solution which allows the different stakeholders in said supply chain to interact in an e-commerce environment using a digital platform such as a website, a mobile or a tablet application to address the defects presently available in this landscape.

### SUMMARY OF THE INVENTION

It is an object of the present invention to provide a system and method for the efficient management of inventory of near expiry perishable products wherein said system and method allow all stakeholders in a supply chain to interact on an integrated digital platform such as for example, a website, a mobile application or a tablet application or any other tool or device available to that end. The proposed system and method will provide transparency and visibility on such perishable products with near expiry dates throughout the supply chain.

It is an object of the present invention to also reduce the amount of expired products generated by businesses where inventory includes perishable goods and this includes foods & beverages, medical & paramedical products, chemical and agricultural products, cosmetics and others. The ultimate goal would be to prevent any and all perishable goods from reaching expiration and being discarded as waste.

It is yet another object of the present invention to provide a system and method of management of inventory wherein said system and method will enable suppliers to operate on an easy and strong digital platform to track and manage their near expiry products.

As another aspect of the present invention, consumers or clients on the proposed system are able to save money and increase their purchasing power by knowingly getting easy access to near expiry items at a discounted price on said digital platform.

In another aspect of the present invention, the proposed system and method will result in alleviating the environmental impact of the problem of disposing of expired products. As an embodiment of the present invention, the efficient disposition for proper use of more products prior to their expiration will contribute to alleviating said environmental impact as a result of the consumption of the near expiry items before their actual expiry date.

It is another aspect of the present invention to prevent adverse events on end consumers or end users of said perishable goods, as a result of consuming or utilizing said goods after expiration. As an example, pharmaceutical products and certain foods can cause poisoning or infection, in certain cases severe, irreversible and sometimes fatal, if consumed after their expiration date. It is the object of one of the embodiments of the present invention, to adequately and properly manage perishable goods and products to avoid such eventualities by ensuring that all such goods or products are timely and safely distributed.

As another aspect of the present invention, there is provided a method for the management of the inventory of near expiry items that uses a digital platform such as a website, a mobile application or other convenient and broadly enabling electronic devices and solutions. The implementation and use of the system or method of the present invention is not to be limited to presently known only digital enabling devices, methods and processes, but also to developing and future such tools and devices which function is as described herein.

As another aspect of the present invention, there is provided a method for the inventory management of near expiry items that helps the vendors of nearby expiry items to sell their goods and prevent them from being returned to the exporter.

As another aspect of the present invention, there is provided a method for the inventory management of near expiry items that include an item counter to reduce the stock of a nearby expiry item according to the number of items sold.

As another aspect of the present invention, there is provided a method for the inventory management of near expiry items that include a time counter to reduce the number of days available to buy a near expiry item as time passes.

### BRIEF DESCRIPTION OF THE DRAWINGS

The invention will be described with reference to the accompanying drawing, which illustrates preferred embodiments of the present invention without restricting the scope of the invention thereof, and in which:

FIG. 1 represents a general implementation of the proposed invention. Perishable goods and products are manufactured or processed and an expiration date is assigned for each product according to acceptable nrms and standards as set by laws and regulations. This expiration date is assigned to each product and entered into a database, which becomes available on the cloud for access by different stakeholders in the supply chain on an electronic platform.

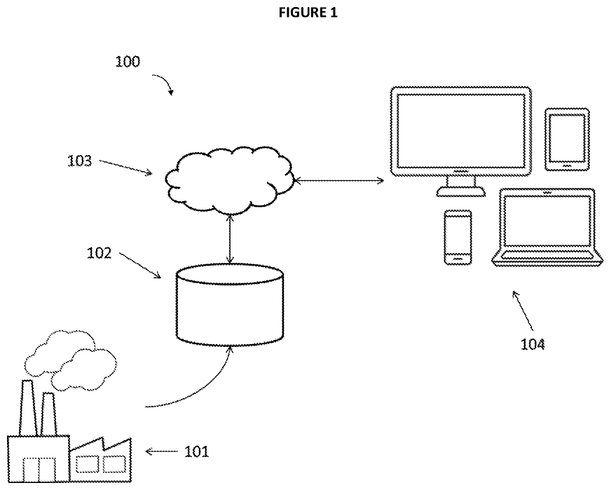

FIG. 2 shows an instance wherein inventory is built-up and defined by specific pricing. As pre-defined dates from the pre-set expiration date are reached, the pricing is adjusted to promote the near expiry items, and in certain embodiments these items are prioritized and pushed on the end buyer at a discounted price.

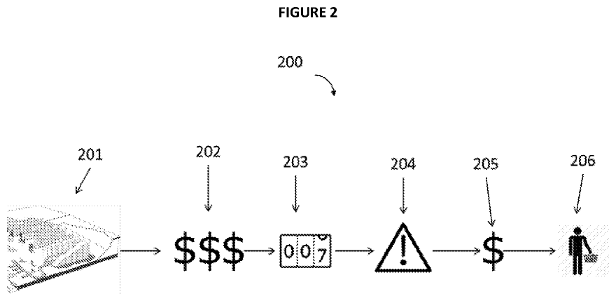

### DETAILED DESCRIPTION OF THE INVENTION

There are two types of perishable goods and products. The first kind relates to natural products such as produce including fruits and vegetables as well as meats, poultry and seafood. Some of such products are packaged and assigned a “use by” date and an “expiration” date. Other such products are maintained in their natural fresh state, without any processing. In the latter case, no expiration date can be assigned or referenced as the actual expiration of such products will depend on storage conditions within the supply chain. The said storage conditions include temperature, exposure to oxygen, exposure to oxidants, moisture, light, UV rays, etc. It is possible to monitor the expiration of these products by using special monitors linked to sensors which can measure the adequate conditions described herein above. The present disclosure will not develop on such sensors and monitors as these have been described elsewhere in prior art. The system and method of the present invention however may be applicable to such monitored products and it is understood that although the examples and embodiments disclosed herein will apply to the second type of perishable products, that the said system and method may also be applied to this type, although not specifically disclosed in the embodiments herein.

The second type of perishable goods and products relates to manufactured products which include canned or bottled products, packaged products and refrigerated products, processed products supplied in some form of packaging and under conditions of vacuum or frozen. These extend to medicines and other pharmaceutical products as well as para-pharmaceutical products, cosmetics, chemicals, agricultural products and more. While it may not be possible to list every single possible type of product to which the system and method of the present invention can be applicable to, it is to be assumed that if a product is defined as perishable and is assigned an expiration date, then said product is de facto included and covered by the present system and method disclosed by the present invention.

Perishable goods and products which have reached expiration are generally disposed of and constitute a varying portion of the waste generated from such products. Furthermore, and in many countries and regions with low literacy or a relatively uneducated populace, it is not uncommon for end users or consumers to utilize expired products, which may have adverse effects or cause adverse events. Such effects and events can include infections, poisoning or other; and in some cases maybe irreversible or even fatal.

In the embodiments of the present invention, there is disclosed a system to manage the inventories of perishable goods and products as disclosed herein above wherein the said perishable goods and products are monitored from once their expiration date has been assigned at the very early stages of the supply chain and throughout the supply chain until expiration and disposal thereof. For purposes of simplification, the term expression “perishable goods and products” will be hereinafter substituted by the term “perishables.”

It is an object of the embodiments disclosed herein below as examples to address many of the present issues and defects in managing perishables. The proposed system and method aim to minimize or completely abolish waste regenerated for expired perishables. It is also the intention of the proposed system and method to help avoid adverse effects or adverse events resulting from the sale and consumption of expired perishables.

In a preferred embodiment of the present invention, the expiration date of said perishables is captured into an electronic database (102) and linked to the other specific identifiers of said product, for example with the product's Radio Frequency ID (RFID) or serial number or QR code or bar code or other such unique identifier assigned to each individual perishable product. Once uploaded in said electronic database and linked as described, each product becomes searchable and identifiable by its expiration date in addition to its other identifiers. In the present embodiment, it may be possible to track the said product either by one of its unique identifiers or as part of products based on their expiration date as it exists on a digital cloud (103).

In another embodiment of the system presently disclosed, a range of dates is defined in the system based on the expiration date of each perishable product included in said system and referred to herein as the counter (203), whereby near expiry products are pushed or promoted to the head of an inventory and thus enabling the first-expiry, first to sell model as defined by said counter (203). The different stakeholders in the supply chain can easily monitor said expiration dates by accessing said system on the cloud (103), the expiration date of their said inventory and ensure that near expiry products are pushed forward in the said supply chain and if needed, priced preferentially (205) to be even further promoted in the supply chain for earlier disposal and use by end users. In the said preferred embodiment, push notifications can be implemented in and by the system which is enabled by the counter (203) thus in turn enabling the holder of the inventory to manually or automatically initiate the requisite procedure within the system to promote said near expiry products or in a further embodiment, to be able to identify near expiring identical perishable at an alternate physical location or available for online purchasing.

In a further embodiment, said system and method enables different stakeholders in a supply chain to identify near expiry products and all related information concerning them such as location of availability, ability to obtain, accessibility, etc. In one example, an end user desires to purchase a perishable product from a specific physical location. Upon checking said product, vendor and/or consumer are automatically notified of the existence of the identical product with a nearer expiration date in an alternate location. In such manner, the nearer to expiry product can be promoted for immediate sale thus preventing the possibility of said product from reaching its expiration date and going to waste.

In a preferred embodiment of the system of the present invention, there is disclosed a digital system, for example and merely for description on currently commonly existing tools, a computer system, a digital network, digitally readable medium accessible remotely and securely by the different stakeholders in the supply chain management in which the said perishable product is listed. In the said system, different stakeholders have different access and edit permissions depending on their role and position in said supply chain.

In a preferred embodiment of the said system, the stakeholder responsible for defining the expiration date on the perishable product is the only stakeholder with permission to populate the proposed database with the expiration date. Permission to edit or make any sort of change to the expiration data is limited to the highest level of permissions and authorization. In the preferred embodiment of the said system, once an expiration date has been assigned to a product and this latter enters the supply chain, no changes shall be allowed or made, and the said product will be defined by its expiration date as well as other identifiers to enable downstream processing and promotion as needed by downstream stakeholders in the supply chain.

In the preferred embodiment of the present invention, the expiration date can be defined using Julian dating system, Gregorian dating system, Hijri dating system and for the purposes of the present invention, any other dating system which is presently used in specific countries or regions or may be used to accurately keep track of dates. It is further an object of the present invention that the date may be represented using a coding system which may utilize numbers, letters, alphanumerical characters, symbols and others, or any combination thereof. It is an object that the proposed system of the present invention is developed to enable and to recognize a variety of inputs, depending on the user(s) or stakeholder(s) or the need to properly and adequately manage near expiry products using a pre-defined counter (203).

In a preferred embodiment of the method of the proposed system, an expiration date for a perishable product as defined herein is set and assigned, and constitutes a key characteristic identifier of said product. Said expiration date is linked to other attributes and characteristics used in tracking said product such as, but not limited to, a bar code or a QR code. In the present method, once said product is entered in an inventory (201), preferably an electronic one, it becomes defined by its expiration date in addition to the other characterizing IDs which define the uniqueness of said product.

As described herein above, the date can be attributed any format required and necessary or alternatively be provided as a code. Once a product enters the supply chain with its specific expiration date, it is an embodiment of the present method to begin tracking said product based on said expiration date. In a preferred embodiment, the different stakeholders of the supply chain where said product is channeled will be made aware of the products availability and its expiration date on the cloud (103).

Said product becomes part of an electronic database (102) and remains in that database or is transferred to other similar databases or on the digital cloud (103) whereby the expiration date remains one of the identifying characteristics thereof. In a preferred embodiment, the said database may be accessed by different stakeholders of a supply chain including the final user which may be the end consumer.

It is an object of this invention to provide for a digital interface using any visualizing digital device (104), including but not limited to a computer monitor, a laptop screen, a handheld device including a tablet or a phone, or any other current and future technology for displaying or projecting images and/or data or for use to provide sensorial recognition.

It is an object of this invention that a search algorithm be used to catalog, manage and search for perishables according to their expiration date as assigned thereof. It is also an object of this invention that the products may display in different colors or forms based on their expiration date, whereby in one such embodiment, the products closest to near expiry appear in red and those with the longest time for expiration appear in green. It is a further embodiment that a counter (203) will be set and defined to enable said feature of recognition based on period to expiration.

It is an object of the method of this invention that the color or form assigned to a product according to its expiration date is pre-defined for each product based on a number of factors such as expected sales volume, seasonal promotions, availability, shipping times, etc. thus ensuring that an accurate and adequate notification system which will accurately and predictably notify the various stakeholders in a supply chain on the optimal processing of said perishables based on the expiration deadline for each and the ease of disposing of said perishables through normal channels.

It is an object of the method of the present invention of tracking said perishables that as the said perishable ages within a supply chain, the same is promoted into a next level category of near expiration. This feature may be enabled within an algorithm defined in the counter (203) of the proposed system. It is a further object of said method that whenever a product progresses from one level to another, the stakeholder(s) involved is(are) notified of said products' progression into said next level. Said next level is defined by a period of time which is closer to the expiration date than the previous level. The said levels act as counters from the assignment of the expiration date for a product until the actual expiration date. Since different products have different market sizes and move in a supply chain to the end consumer depending on the end consumer's purchasing habits, the algorithm for defining when each product advances in level takes into account various factors such as consumer habits, seasonal habits, location of product's point of sale and many other variables such as weather, change in population size, change in population distribution, changes in economy, changes in purchasing power, etc. it is an object of this invention that said algorithm is based on a pseudo artificial intelligence whereby all parameters that may affect how fast or slow a product moves in a supply chain to the end consumer are calculated on a regular basis thus allowing real time movement of products through levels to ensure that the nearest ending expiring products are nearly guaranteed sale and consumption prior to expiring.

In a preferred embodiment of the present method, an algorithm for calculating the best sales price or discount is implemented and applied on products as they move through levels of near expiration. Such an algorithm will allow a vendor to sell near expiring products sooner by attracting consumers to purchase more or faster as a result of the discounted pricing scheme. Combined, these two drivers will result in less near expiration products in the supply chain thus minimizing waste from discarded expiring products. The counter (203) plays an essential role in defining these parameters and enabling the move of the products in the supply chain to the end user or consumer.

It is further the goal of said system and method to enable the different stakeholders to be aware of nearby or online availability of identical products which are nearer expiration. It is an object of the present system and method to ensure that identical products are visible across an inventory and supply chain thus notifying the various stakeholders where the nearest to expiration perishable is physically available to enable its push to all stakeholders in said supply chain. In the present system and method, a vendor and or/end user may have immediate access to the nearest expiry product thus addressing the objectives of said system and method. On the one hand, the inventory of near expiry perishables will decrease and possibly may become zero; and on the other hand, end users are empowered to have access to such products and a discounted price.

In an embodiment of the present system, near expiring perishables which do not move out of the supply chain through the normal process, or based on the proposed algorithm cannot be processed through the normal channel in a timely manner based on the different criteria, may be designated for donation to non-profit organization thus creating an opportunity for possible tax deduction for voluntary and benevolent donations instead of going to waste due to expiration with a complete loss.

It is an embodiment that the system and the method of the present invention provide a global solution for minimizing losses and generating waste due to expired perishable products of any sort through the proper management of said perishable products in a supply chain. It is an object of the present invention to provide a system by which expiration dates on perishable products are monitored and executed upon by the different stakeholders in said supply chain. It is also an object of the present invention to provide a method by which the different stakeholders are empowered to view and manage perishable products based on their expiration dates, thus knowledgeable pulling and pushing said products in a supply chain to maximize benefit from said products. Said benefits vary from one stakeholder to another in said supply chain in that a vendor benefits from selling more products prior to their expiration and disposal; vendors can also benefit through a tax break donation system of near expiring products rather than disposing of the same to waste; end consumers benefit by being a able to purchase discounted products and increase their purchasing power.

Although the above description contains many specifics, these should not be construed as limitations on the scope of the invention but is merely representative of the presently preferred embodiments of this invention. The embodiment(s) of the invention described above is(are) intended to be exemplary only.

1. A system for electronically managing perishable goods in a supply chain, wherein said system comprises:
a. assigning an expiration date to said perishable goods;
b. entering said perishable goods into an electronic database;
c. identifying said perishable goods with said expiration date;
d. linking said database to one or more devices, wherein said one or more devices monitor expiration dates to provide real time data on the expiration of said perishable products;
e. categorizing said perishable products according to remaining period to expiration date;
f. notifying a user of said one or more devices of the expiration date and category of said perishable products, wherein said user is a vendor or a consumer;
g. allowing said vendor to electronically manage status of said perishable products;
h. allowing said consumer to purchase said perishable products.

2. The system according to claim 1, wherein said perishable goods consist of natural produces, processed produces, vegetables, fruits, meats, poultry, seafood, packaged goods, frozen goods, canned goods, medicaments, para-pharmaceutical products, chemicals, agrochemicals and agricultural products.

3. The system according to claim 1 wherein said categories enable said vendor to identify near expiration products.

4. The system according to claim 3 wherein said vendor may promote the nearest expiring products.

5. The system according to claim 1 wherein said consumer may choose to buy near expiring products at a discount.

6. The system according to claim 1 wherein said system decreases waste from expired perishable goods.

7. A method for electronically managing perishable goods in a supply chain wherein said method comprises:
a. an electronic platform which consists of a plurality of databases, an electronic interface, a software application and a plurality of electronic devices;
b. an electronic commerce platform;
c. an electronic counter;
d. a platform for a plurality of vendors and a plurality of consumers to interact

8. The method according to claim 7 wherein said electronic platform enables the real time monitoring and management of perishable goods based on expiration dates.

9. The method according to claim 7 wherein said method allows for the prioritization of the sale of near expiry perishable goods.

10. The method according to claim 7 wherein said method allows for push notification for near expiring perishable goods.

11. The method according to claim 7 wherein said counter defines the status of a perishable product based on the time left for expiration.

12. The method according to claim 17 wherein said method provides for less waste generated from expired perishable products.
